(19) United States
(12) Patent Application Publication
(10) Pub. No.: US 2013/0106038 A1
(43) Pub. Date: May 2, 2013

(54) Spring Seat to Provide Adjustable Spring Height for Vehicle Suspension System

(71) Applicants: Jason Michael Miyamoto, San Diego, CA (US); Richard Anthony Botello, Lomita, CA (US)

(72) Inventors: Jason Michael Miyamoto, San Diego, CA (US); Richard Anthony Botello, Lomita, CA (US)

(73) Assignee: TAP Worldwide, LLC, Compton, CA (US)

(21) Appl. No.: 13/284,686

(22) Filed: Oct. 28, 2011

(51) Int. Cl. B60G 17/02; B60G 11/14; F16F 1/12

(52) U.S. Cl. 267/286; 267/174

(57) ABSTRACT

A spring seat to define a spring height for a vehicle suspension system including a base cylinder defining an interior cylindrical surface and an exterior cylindrical surface, an external attachment mechanism coupled to the exterior cylindrical surface of the base cylinder to receive a coil spring on either of two opposing surfaces of the external attachment mechanism, and an internal attachment mechanism coupled to the interior cylindrical surface of the base cylinder, the internal attachment mechanism to engage a shock absorber on either of two opposing surfaces of the internal attachment mechanism, the internal attachment mechanism offset along a longitudinal axis of the base cylinder from the external attachment mechanism to provide two separate height settings for the coil spring relative to the shock absorber in the vehicle suspension system.

### FIELD OF THE INVENTION

Embodiments of the invention relate to a vehicle suspension system. Specifically, embodiments of the invention relate to a spring plate that enables spring coil height adjustment in the vehicle suspension system.

### BACKGROUND

Vehicles use a suspension system including a shock absorption system to cushion the ride of the vehicle. The suspension system couples the wheel spindle assembly to the vehicle body such that the wheel spindle assembly can move independent of the vehicle body to avoid transmitting the jostling of the wheel spindle assembly to the vehicle body. The vehicle suspension system includes a set of shock absorbing devices to absorb the energy of the wheel spindle assembly.

The vehicle suspension system includes a set of springs that isolate the vehicle body from the vibrations of the wheel spindle assembly. These springs have a range of motion to provide a separation between the movement of the wheel spindle assembly and the vehicle body. Travel along this range of the spring's motion is dampened by a set of hydraulic valves referred to herein as shock absorbers. The exact loads of the springs and resistance provided by the shock absorbers are design considerations that influence the handling and ride of the vehicle.

In many suspension systems, the shock absorbers are directly connected with the springs and are part of an assembly that defines the spring height, amongst other characteristics of the vehicle suspension system. In these suspension systems the shock absorber is coaxially located within the spring. The springs are often coiled or helical. The shock absorber includes an upper mount that is attached to a stop plate and a lower mount that is attached to the wheel spindle assembly. A spring seat is a plate or flange attached along the length or at one end of the shock absorber. The spring is disposed between the spring seat and the stop plate. The placement of the spring seat relative to the stop plate then determines the spring height. The shock absorber can define a set of attachment points for the spring seat to provide adjustability to the spring height. However, this increases the complexity of the vehicle suspension system and the likelihood of failure due to improper adjustment of the spring seat when adjusting the spring height, especially for individuals without extensive experience with the adjustment mechanism and vehicle suspension system.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1A is a diagram of one embodiment of a portion of a vehicle suspension system with a first spring height.

FIG. 1B is a diagram of one embodiment of the portion of the vehicle suspension system of FIG. 1A at a second spring height.

FIG. 2 is a diagram of one embodiment of the spring seat attached to the shock absorber absent the coil spring.

FIG. 3 is a diagram illustrating a cross section of one embodiment of an adjustable spring seat.

FIG. 4 is a flowchart of one embodiment of a process of adjusting the spring height by reversing an orientation of the spring seat.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

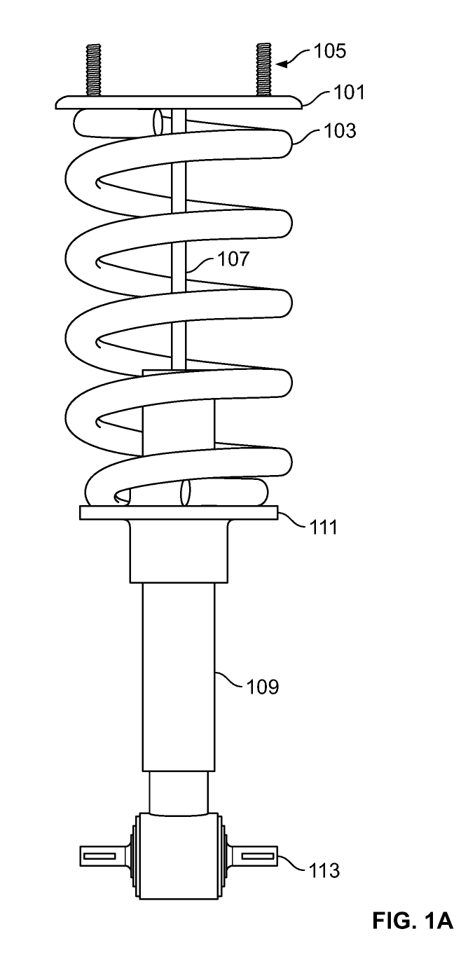

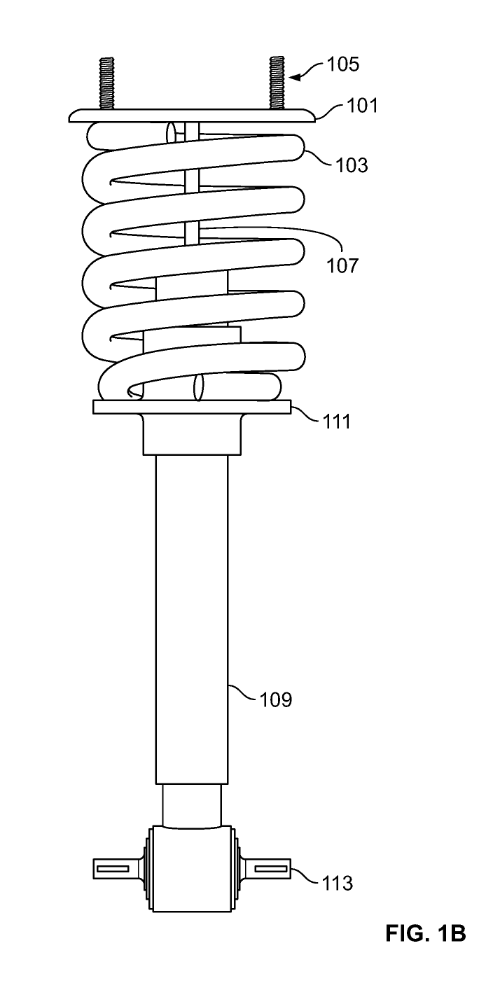

FIG. 1A is a diagram of one embodiment of a portion of a vehicle suspension system with a first spring height. The vehicle suspension system includes a spring 103, a shock absorber 109 and an adjustable spring seat 111. This assembly can be connected to a wheel spindle assembly at the lower mount 113 and to the vehicle body at the upper mount 105. The illustrated assembly is provided by way of example and not limitation. The structures, features and principles described herein can be applied to any vehicle suspension system where the shock absorber is coaxially disposed within the coil or helical spring and where the spring seat is removably coupled to the exterior of the shock absorber. In one embodiment, the vehicle suspension system is designed to be used in the front suspension of the vehicle. In other embodiments, the vehicle suspension system is designed to be used in either the front or rear suspension of the vehicle.

The spring 103 can be any size, weight and rate of spring. The spring 103 can have a coiled, helical or similar shape defining an interior channel through which a shock absorber can be disposed to dampen the travel of the spring within the spring's range of motion. The size, shape, weight and rate of the spring can be selected for a vehicle suspension system based on the typical load of the associated vehicle and the desired handling and ride characteristics. The spring 103 can be formed from any metal or alloy with appropriate elastic qualities and similar properties for forming a torsion spring.

The shock absorber 109 can be any type of shock absorber including a hydraulic or pneumatic shock absorber. The shock absorber 109 can include a cylindrical body containing a fluid or gas, a piston head and valves that provide dampening for the attached spring 103. The shock absorber 109 can have a unitary cylindrical exterior or can have separate segments such as an upper and lower reservoir.

The shock absorber 109 can include an upper mount 105 or be attached to an upper mount 105 through a piston 107. The upper mount 105 can be attached to or include a stop plate 101 and can include an attachment mechanism for bolting or similarly attaching the shock absorber 109 and spring 103 to a vehicle body. The shock absorber 109 can also include a lower mount 113. The lower mount 113 can include an attachment mechanism for coupling the shock absorber 109 to a wheel spindle assembly. The attachment mechanism can include a set of pins or similar attachment mechanism.

The shock absorber 109 can also define an attachment mechanism along the length of its cylindrical body for engaging the spring seat 111. The attachment mechanism can be a lip, flange, clip or similar engagement mechanism for interfacing with the spring seat 111. The spring seat 111 can include a complementary attachment mechanism that engages the attachment mechanism of the shock absorber 109 such as a collar, ring, lip, flange, clip or similar engagement mechanism.

The spring seat 111 can be a cylindrical device designed to be coaxially disposed over the shock absorber 109 and to engage the shock absorber 109 with an attachment mechanism defined within the interior channel of the spring seat 111. The spring seat 111 can be a molded, extruded, milled or similarly crafted article. The spring seat 111 can be formed from any metal, metal alloy or similar material with sufficient material strength to carry the load of the spring and vehicle. The spring seat 111 can also define an external flange or similar attachment mechanism for engaging the spring 103 and thereby defining a height of the spring 103 that limits the travel of the spring in combination with the stop plate 101.

The spring seat 111 and its internal attachment mechanism are reversible. The spring seat 111 can engage the shock absorber 109 in either orientation. Each orientation of the spring seat 111 provides a different spring height due to an offset between the location of the internal attachment mechanism that engages the shock absorber 109 and the location of the external flange that engages the spring 103. These two attachment mechanisms are not concentric and are offset along the length of the spring seat 111. The distance between the two attachment mechanisms and the resulting differences in spring height can range from 0.25 inches to four inches depending on a desired height adjustment design appropriate for the associated vehicle.

The spring seat 111 can have two cylindrical sections separated by the external flange, such that each of the cylindrical sections has a different length. The components of the spring seat 111 including the internal attachment mechanism, the external attachment mechanism, the cylindrical sections and similar components that can all be integrally formed or any combination of these features that can be integrally formed. The embodiment providing integral formation of the components provides an improved reliability in the adjustment of the spring height due to the reduction in the number of parts and the possible methods for the shock absorber 109 to be engaged by the spring seat 111.

FIG. 1B is a diagram of one embodiment of the portion of the vehicle suspension system of FIG. 1A at a second spring height. In this embodiment, the spring seat 111 has a reversed orientation relative to the installation in FIG. 1A. The other components of the vehicle suspension system are installed in the same manner as depicted in FIG. 1A. In this embodiment of FIG. 1B, the spring 103 has a smaller height than the installation of FIG. 1A. The spring seat 111 is identical to the spring seat 111 illustrated in FIG. 1A, however, it has been re-installed with a reversed or opposite orientation.

The reversed orientation is demonstrated by the labels 111A and 111B in FIGS. 1A and 1B, which identify opposite edges of the spring seat. In the first installation of FIG. 1A the first spring seat edge 111A is positioned proximate to the upper mount 105 relative to a second spring seat edge 111B. The second spring seat edge 111B is positioned proximate to a lower mount 113 relative to the first spring seat edge 111A. In the second installation of FIG. 1B the first spring seat edge 111A is positioned proximate to the lower mount 113 relative to the second spring seat edge 111B. The second spring seat edge 111B is positioned proximate to the upper mount 105 relative to the first spring seat edge 111A. The difference in spring height between the two illustrated installations can range from 0.25 inches to four inches dependent on the design and placement of the internal attachment mechanism in the spring seat 111 relative to the placement of the external attachment mechanism. The offset between the two attachment mechanisms defines the difference in spring height. In the embodiment illustrated in FIG. 1B, the internal attachment mechanism may be adjacent one end 111A of the spring seat 111 causing a larger shift in spring height when the spring seat 111 is reversed than if the internal attachment mechanism had been more centrally located within the spring seat.

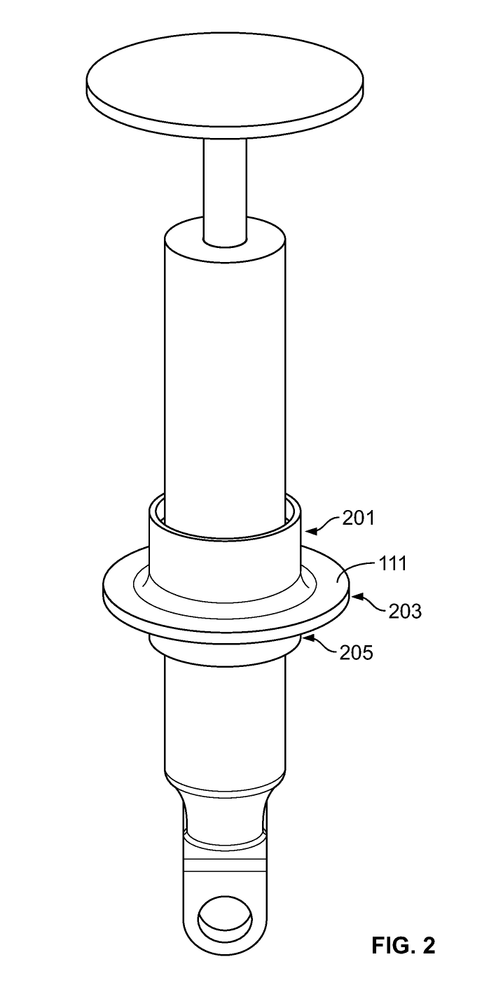

FIG. 2 is a diagram of one embodiment of the spring seat attached to the shock absorber absent the coil spring. In this illustration the shape of the spring seat 111 and its position relative to the shock absorber 109 can be more clearly seen with the absence of the coil spring. The spring seat 111 has an overall cylindrical exterior and interior shape. The exterior cylinder surface and interior cylinder surface are concentric and coextensive save for the internal and external attachment mechanisms.

The external attachment mechanism 203 can be a flange, ridge, collar or similar structure that is attached to or integral with the base cylinder of the spring seat 111. This external attachment mechanism 203 can define two opposing surfaces 207A, B. Each of these external attachment mechanism 203 surfaces 207A, B can engage a coil spring when the spring seat 111 is oriented with the respective surface 207A, 207B facing the coil spring. The opposing surfaces 207A, B of the external attachment mechanism 203 can be roughly orthogonal to the exterior cylinder surface. The diameter of the external attachment mechanism 203 and the surface areas of the surfaces 207A, B can vary dependent on the size of the coil spring to be received and the diameter of the shock absorber to which the spring seat is attached. In one embodiment, the external attachment mechanism extends outward from the exterior cylindrical surface 0.25 to four inches. The external attachment mechanism can have a thickness of 0.5 inches to one inch dependent on design of the vehicle suspension system.

The external attachment mechanism 203 can have any placement between the two edges 111A, B of the spring seat 111. The position of the external attachment mechanism 203 along the length of the cylinder of the spring seat 111 defines an upper cylinder portion 201 and a lower cylinder portion 205. The upper cylinder portion 201 and lower cylinder portion 205 are asymmetrical relative to the cross-plane of the external attachment mechanism 203 or the internal attachment mechanism. The upper cylinder portion 201 and lower cylinder portion 205 can have the same internal and external cylinder diameters.

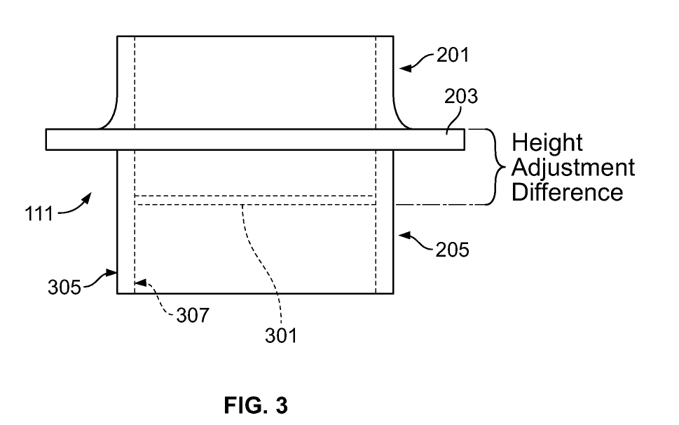

FIG. 3 is a diagram illustrating a cross section of one embodiment of an adjustable spring seat. This diagram isolates the spring seat 111 from the shock absorber and provides a view of the internal cylinder of the spring seat 111. The wall 307 of the spring seat 111 can have any thickness or height dependent on design considerations for interfacing with a shock absorber and coil spring as part of a vehicle suspension system. The thickness of the wall 307 can be uniform save for the internal attachment mechanism 301 and external attachment mechanism 203 or the thickness of the wall 307 can vary over the length of the spring seat 111. In one embodiment, the internal attachment mechanism can be defined by a change in the wall 307 thickness to create a lip that the attachment mechanism of the shock absorber engages (e.g., a wall, edge or collar on the exterior of the shock absorber).

The internal attachment mechanism 301 can be a lip, ridge, ring, collar or similar structure attached to or defined by the interior wall 307 of the spring seat 111. The internal attachment mechanism 301 can complement an attachment mechanism of the shock absorber to secure the spring seat 111 to the shock absorber independently or to secure the spring seat 111 to the shock absorber in combination with the coil spring. The internal attachment mechanism 301 can be positioned within the spring seat 111 at any point along the length of the interior cylinder or at either end of the spring seat 111. The internal attachment mechanism 301 can define opposing surfaces for engaging the shock absorber in each orientation. The internal attachment mechanism 301 can define a structure that extends inward orthogonal to the interior surface 307 of the spring seat. The internal attachment mechanism 301 can extend inward 0.1 to one inches and have any thickness (e.g., 0.5 inches to one inch) dependent on the complementary structure of the attachment mechanism of the shock absorber and required material strength.

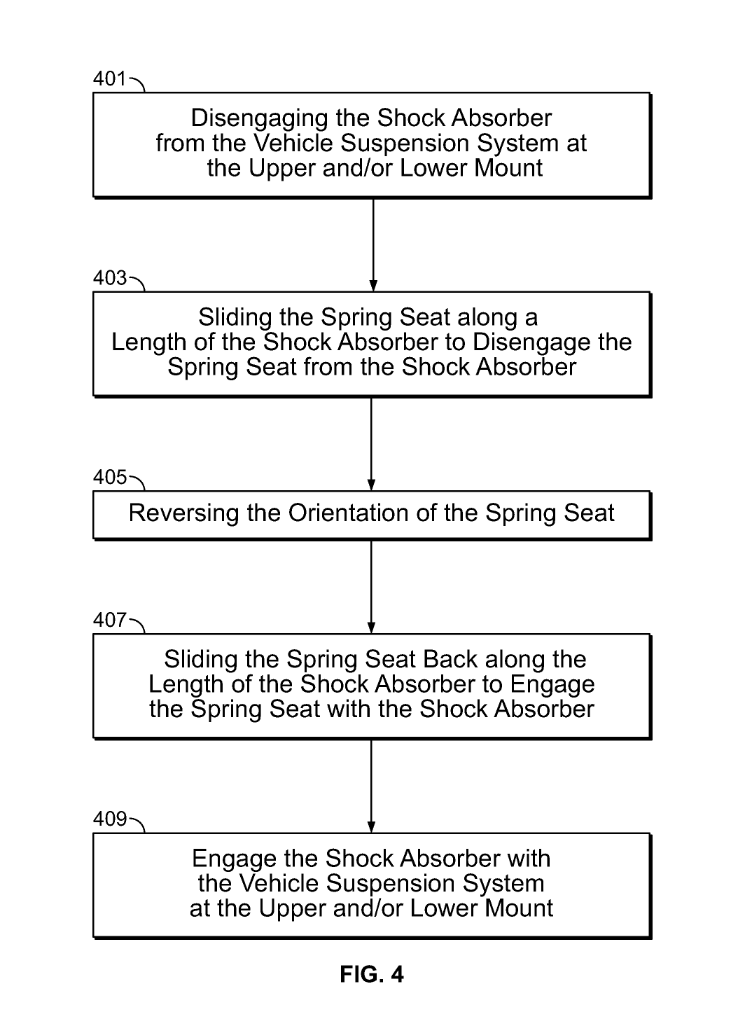

FIG. 4 is a flowchart of one embodiment of a process of adjusting the spring height by reversing an orientation of the spring seat. The adjustment process can be carried out by an auto mechanic, a car owner or other individual. In one embodiment, the process can also be an automated process. The example embodiment assumes that the vehicle suspension system has already been installed and that the owner desires to adjust the current spring height of the vehicle suspension system, One skilled in the art would understand that the steps and features of the process can also be applied to an initial or original assembly process.

The adjustment process can be initiated by disengaging the shock absorber from the vehicle suspension system at the upper and/or lower mount (Block 401). The process could be completed in some instances by disengaging only one end of the shock absorber dependent on the vehicle suspension system. In other embodiments, both ends of the shock absorber may need to be disengaged from the wheel spindle assembly and vehicle body, respectively. Also, the shock absorber is likely to be disengaged from the coil spring to provide access to the spring seat.

The spring seat can slide over the length of the shock absorber to disengage the spring seat from the shock absorber (Block 403). In some embodiments, the spring seat internal attachment mechanism may have a release or similar component that must be activated or separately disengaged to free the spring seat from the shock absorber. The freed spring seat can then be reversed such that the orientation of the cylinder of the spring seat is flipped relative to the orientation of the shock absorber (Block 405).

The reversed spring seat is then slid back over the length of the shock absorber to re-engage the spring seat with the shock absorber (Block 407). Due to the asymmetrical placement of either the interior attachment mechanism or external attachment mechanism of the spring seat (or both attachment mechanisms), the position of the external attachment mechanism is altered compared to the prior position when the spring seat was attached with the opposite orientation. The position of the internal attachment mechanism can alter the position at which the spring seat engages the shock absorber and as a result the position of the external attachment mechanism alters the spring height of the vehicle suspension system. The shock absorber can then be re-engaged with either the wheel spindle assembly and/or the vehicle body at the lower mount and upper mount, respectively (Block 409). The shock absorber and spring seat can also re-engage the coil spring adjacent the upper mount of the shock absorber.

It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A spring seat to define a spring height for a vehicle suspension system comprising:
a base cylinder defining an interior cylindrical surface and an exterior cylindrical surface;
an external attachment mechanism coupled to the exterior cylindrical surface of the base cylinder to receive a coil spring on either of two opposing surfaces of the external attachment mechanism; and
an internal attachment mechanism coupled to the interior cylindrical surface of the base cylinder, the internal attachment mechanism to engage a shock absorber on either of two opposing surfaces of the internal attachment mechanism, the internal attachment mechanism offset along a longitudinal axis of the base cylinder from the external attachment mechanism to provide two separate height settings for the coil spring relative to the shock absorber in the vehicle suspension system.

2. The apparatus of claim 1, wherein the offset provides a height adjustment difference of one to six inches.

3. The apparatus of claim 1, wherein the interior cylindrical surface of the base cylinder defines an interior cylinder with a diameter that is complementary to an outer surface diameter of the shock absorber.

4. The apparatus of claim 1, further comprising:
a stop plate coupled to an upper mount of the shock absorber; and
the coil spring coupled to the spring seat at one end and the stop plate at the other end.

5. The apparatus of claim 1, wherein the external attachment mechanism is integrally formed with the base cylinder.

6. The apparatus of claim 1, wherein the interior attachment mechanism is integrally formed with the base cylinder.

7. The apparatus of claim 1, wherein the external attachment mechanism has a thickness of one inch to half an inch.

8. The apparatus of claim 1, wherein the external attachment mechanism extends one inch to four inches orthogonal to the exterior cylindrical surface.

9. The apparatus of claim 1, wherein the internal attachment mechanism has a thickness of 0.25 inches to one inch.

10. The apparatus of claim 1, wherein the internal attachment mechanism extends from 0.25 inches to 1 inch orthogonal to the interior cylindrical surface.
